(19) United States
(12) Patent Application Publication
(10) Pub. No.: US 2024/0128766 A1
(43) Pub. Date: Apr. 18, 2024

(54) POWER STORAGE SYSTEM

(71) Applicant: TOYOTA JIDOSHA KABUSHIKI KAISHA, Toyota-shi Aichi-ken (JP)

(72) Inventor: Yoshiaki KIKUCHI, Toyota-shi Aichi-ken (JP)

(73) Assignee: TOYOTA JIDOSHA KABUSHIKI KAISHA, Toyota-shi Aichi-ken (JP)

(21) Appl. No.: 18/234,934

(22) Filed: Aug. 17, 2023

(30) Foreign Application Priority Data
Oct. 12, 2022 (JP) 2022-163986

(51) Int. Cl. H02J 7/00

(52) U.S. Cl. CPC H02J 7/0019; H02J 7/00714; H02J 7/007182; H02J 2207/20

(57) ABSTRACT

The power storage system includes a power converter, a plurality of assembled batteries, and a control device. When there is a first assembled battery in which a predetermined time has elapsed since the previous full charge of the plurality of assembled batteries when each of the assembled batteries is charged, the control device charges the first assembled battery until the full charge, and adjusts the storage amount of the second assembled battery other than the first assembled battery in the plurality of assembled batteries so that the sum of the storage amounts after the charge of each of the assembled batteries becomes a predetermined amount.

### CROSS-REFERENCE TO RELATED APPLICATION

This application claims priority to Japanese Patent Application No. 2022-163986 filed on Oct. 12, 2022 incorporated herein by reference in its entirety.

### BACKGROUND

### 1. Technical Field

The present disclosure relates to a power storage system.

### 2. Description of Related Art

Japanese Unexamined Patent Application Publication No. 2014-103804 (JP 2014-103804 A) discloses a battery system in which a plurality of assembled batteries is connected in parallel. The battery system of JP 2014-103804 A includes a higher-level control device that transmits an instruction to equalize voltages of the plurality of assembled batteries based on the voltages of the assembled batteries, and a battery management device that equalizes voltages of the assembled batteries based on the instruction transmitted from the higher-level control device. The battery management device includes an assembled battery for adjustment that charges each cell of the assembled battery. In the battery system, after a plurality of cells is balanced in the assembled battery using the assembled battery for adjustment, balance is performed between the plurality of assembled batteries.

### SUMMARY

In order to improve the estimation accuracy of the state of charge (SOC) of the battery, the assembled battery needs to be fully charged. However, in a power storage (battery) system in which a plurality of assembled batteries is connected in parallel, there is a case where one of the assembled batteries is not fully charged. In such a power storage system, it is desired from the viewpoint of cost reduction and the like to make the assembled battery fully charged without using the assembled battery for adjustment indicated in JP 2014-103804 A.

The present disclosure has been made in order to solve the above problem, and an object thereof is to provide a power storage system capable of fully charging an assembled battery without using a battery for adjustment.

A power storage system according to a first aspect of the present disclosure is a power storage system that performs charging and discharging with an external system. The power storage system includes: a power converter connected to the external system; a plurality of assembled batteries used for the charging and discharging and connected in parallel with each other to the power converter; and a control device that controls an operation of the power converter such that a sum of a power storage amount after charging of each of the assembled batteries becomes a predetermined amount when each of the assembled batteries is charged. When each of the assembled batteries is charged and there is a first assembled battery in which a predetermined time has elapsed since a previous full charging among the plurality of the assembled batteries, the control device charges the first assembled battery until the first assembled battery is fully charged. When each of the assembled batteries is charged and there is the first assembled battery in which the predetermined time has elapsed since the previous full charging among the plurality of the assembled batteries, the control device adjusts a power storage amount of a second assembled battery other than the first assembled battery among the plurality of the assembled batteries such that the sum of the power storage amount after charging of each of the assembled batteries becomes the predetermined amount.

According to the above configuration, it is possible to fully charge the first assembled battery of the plurality of assembled batteries by using the plurality of assembled batteries that performs charging and discharging with the external system. Therefore, it is possible to fully charge the first assembled battery without using an assembled battery for adjustment that is different from the plurality of assembled batteries that performs charging and discharging with the external system.

In some embodiments, an error between an integrated value of a current when the assembled battery is charged or discharged for a prescribed time and a theoretical value of a current flowing in the prescribed time is calculated for each of the assembled batteries prior to an actual operation of the power storage system. A length of the predetermined time is set for each of the assembled batteries prior to the actual operation based on the error. The length of the predetermined time is set shorter as the error becomes larger.

When the above error is large, the estimation accuracy of the state of charge (charge rate) is low. By fully charging the first assembled battery at an early stage, it is possible to improve the estimation accuracy of the state of charge of the first assembled battery. Therefore, as described above, the larger the error is, the shorter the predetermined time for determining whether to execute full charging is set, and thus the estimation accuracy of the state of charge of the first assembled battery can be quickly increased.

In some embodiments, each of the assembled batteries includes a plurality of cells. A variation in a self-discharge amount of each of the cells is calculated for each of the assembled batteries prior to an actual operation of the power storage system. A length of the predetermined time is set for each of the assembled batteries prior to the actual operation based on a magnitude of the variation. The length of the predetermined time is set shorter as the variation becomes larger.

In some embodiments, as the variation in the self-discharge amount increases, the equalization control of each cell in the plurality of cells in the first assembled battery may be performed at an early stage. When the first assembled battery is fully charged, each cell in the first assembled battery is also fully charged, so that the equalization of the cells in the first assembled battery can be performed. Therefore, as described above, the larger the variation in the self-discharge amount is, the shorter the predetermined time for determining whether to execute full charging is set, so that the equalization of the cells can be performed more quickly for the assembled batteries requiring equalization of the cells.

In some embodiments, each of the assembled batteries includes a plurality of cells. The power storage system further includes a plurality of voltage detection circuits provided in association with each of the plurality of the cells and each detecting a voltage of the cell. A variation in impedance of each of the voltage detection circuits is calculated for each of the assembled batteries prior to an actual operation of the power storage system. A length of the predetermined time is set for each of the assembled batteries prior to the actual operation based on a magnitude of the variation. The length of the predetermined time is set shorter as the variation becomes larger.

The larger the variation of the impedance, the larger the variation of the self-discharge amount. In some embodiments, as the variation in the self-discharge amount increases, as described above, the equalization control of each cell in the plurality of cells in the first assembled battery may be performed at an early stage. When the first assembled battery is fully charged, each cell in the first assembled battery is also fully charged, so that the equalization of the cells in the first assembled battery can be performed. Therefore, as described above, the larger the variation in the impedance is, the shorter the predetermined time for determining whether to execute full charging is set, so that the equalization of the cells can be performed more quickly for the assembled batteries requiring equalization of the cells.

In some embodiments, when power storage amounts of the plurality of the second assembled batteries are adjusted and when the plurality of the second assembled batteries includes a three-way lithium ion battery and an iron phosphate lithium ion battery, the control device controls an operation of the power converter such that a power storage amount of the three-way lithium ion battery is larger than a power storage amount of the iron phosphate lithium ion battery.

The internal resistance of the iron phosphate lithium ion battery is higher than the internal resistance of the three-way lithium ion battery. Therefore, by increasing the power storage amount of the three-way lithium ion battery of the lower resistance at the time of adjustment than the power storage amount of the iron phosphate lithium ion battery (by prioritizing charging of the three-way lithium ion battery), it is possible to reduce the power consumption compared to the case of increasing the power storage amount of the iron phosphate lithium ion battery than the power storage amount of the three-way lithium ion battery.

According to the above disclosure, an assembled battery can be fully charged without using a battery for adjustment.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram for explaining a configuration of a power storage system and an external system;

FIG. 2 is a diagram for explaining a part of a circuit configuration of an assembled battery;

FIG. 3A is a diagram for explaining an outline of a process in a power storage system;

FIG. 3B is a diagram for explaining an outline of a process in a power storage system; and

FIG. 4 is a flow chart for explaining a flow of a process for charging three assembled batteries.

### DETAILED DESCRIPTION OF EMBODIMENTS

Hereinafter, embodiments of the present disclosure will be described with reference to the drawings. In the following description, the same members are denoted by the same reference numerals. Their names and functions are also the same. Therefore, detailed description of the same parts will not be repeated.

### A. Entire Configuration

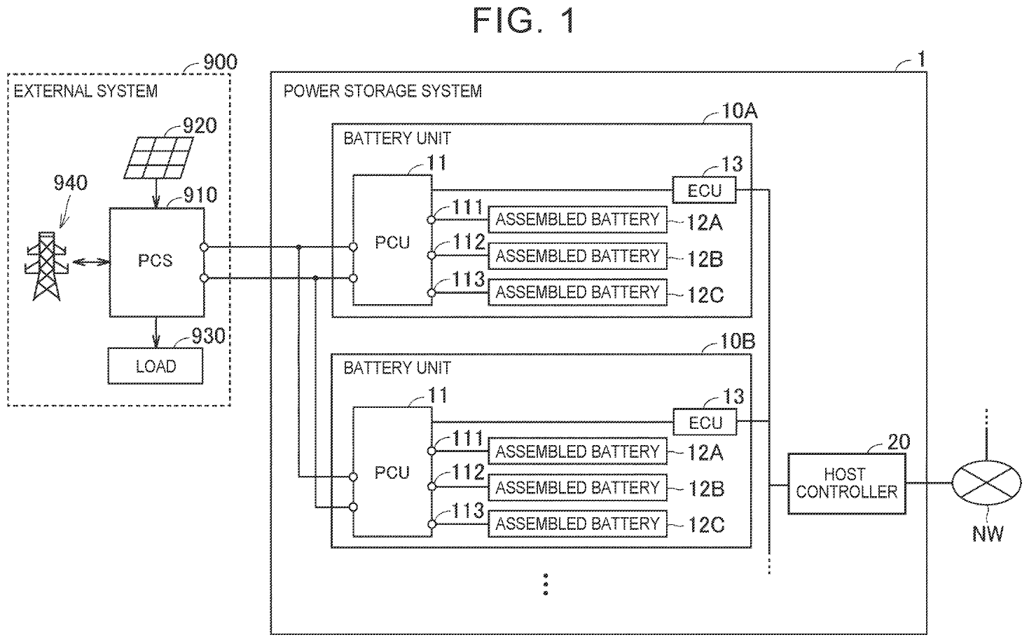

FIG. 1 is a diagram for explaining a configuration of a power storage system and an external system. As illustrated in FIG. 1, the power storage system 1 is connected to an external system 900 by a power line. The power storage system 1 can be supplied with power from the external system 900 and can be discharged to the external system 900.

The power storage system 1 includes a plurality of battery units 10A, 10B, . . . and a host controller 20. In the following description, any one of the plurality of battery units 10A, 10B, . . . is also referred to as “battery unit 10”.

The battery unit 10A includes a Power Control Unit (PCU) 11, an assembled battery 12A and an assembled battery 12B, an assembled battery 12C, and an Electronic Control Unit (ECU) 13.

PCU 11 is a power converter including inverters, DC/DC converters, and the like. In the battery unit 10A, three assembled battery 12A, 12B, 12C are connected in parallel to PCU 11. In particular, the battery unit 10A has three terminals 111, 112, 113 for external connection of PCU 11. The assembled battery 12A is connected to the terminal 111 of the three terminals. The assembled battery 12B is connected to the terminal 112. The assembled battery 12C is connected to the terminal 113.

The assembled battery 12A, 12B, 12C is obtained by packing a plurality of unit batteries of the same type (also referred to as “battery cells”). The assembled battery 12A, 12B, 12C is also referred to as a “assembled battery”. Each of the assembled battery 12A, 12B, 12C is, for example, a ternary lithium ion battery (hereinafter, referred to as a “ternary battery”) or an iron phosphate lithium ion battery (hereinafter, referred to as a “LFP battery”). The internal resistance of LPF cell is higher than the internal resistance of the ternary cell. In particular, in the low-temperature range, the inner resistivity of LPF cell increases.

The battery unit 10B includes a PCU 11, an assembled battery 12A, 12B, 12C, and an ECU 13, similarly to the battery unit 10A. In the battery unit 10B, the type of the assembled battery connected to PCU 11 may be different from that of the battery unit 10A. For example, the battery unit 10A may include, as an assembled battery 12A, 12B, 12C, two ternary batteries and one LFP cell, and the battery unit 10B may include, as an assembled battery 12A, 12B, 12C, one ternary battery and two LFP cells. The combination of assembled batteries included in each battery unit 10 is not particularly limited.

In the following description, any one of the plurality of assembled battery 12A, 12B, 12C is also referred to as “assembled battery 12”.

In the present embodiment, PCU and ECU mounted on the vehicles are diverted as PCU 11 and ECU 13, respectively. Similarly, assembled batteries mounted on vehicles are diverted as assembled battery 12A, 12B, 12C. As described above, the power storage system 1 is constructed by using the components of the vehicle that have become unnecessary. Specifically, the three-phase AC motor connected to PCU of the vehicles is removed, and three assembled batteries (one for each of the U-layer, the V-layer, and the W-layer) are connected. The terminals 111, 112, 113 are terminals for the U layer, terminals for the V layer, and terminals for the W layer, respectively.

The external system 900 includes a Power Conditioning System (PCS) 910, a photovoltaic device 920, loads 930, and a power system 940. The respective battery units (specifically, the respective PCU 11) are connected in parallel to each other with respect to PCS 910.

A PCS 910 is a power converter capable of both AC/DC conversion (AC-to-DC conversion) and DC/AC conversion (DC-to-AC conversion). PCS 910 receives DC power from the photovoltaic device 920, for example. PCS 910 provides AC power to the loads 930. It should be noted that the load 930 includes an electric product (for example, an air conditioner, a lighting fixture, and the like) used in a home. PCS 910 exchanges AC power with the power system 940.

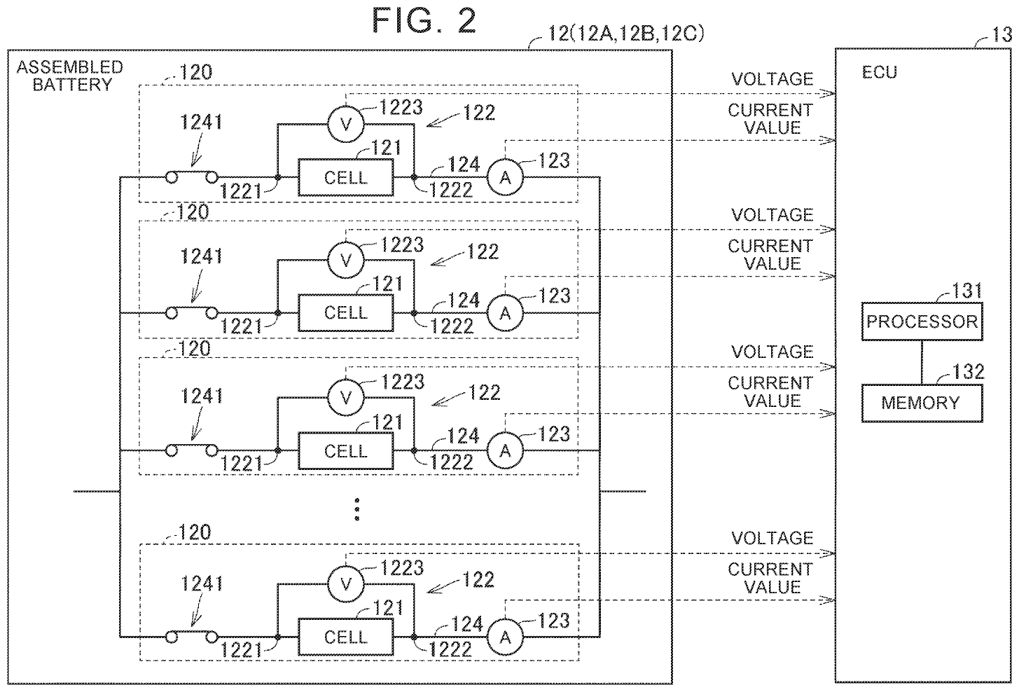

ECU 13 includes a processor and a memory (see FIG. 2) and control the battery unit 10. ECU 13 is communicatively connected to the host controllers 20. When charging each assembled battery 12A, 12B, 12C, each ECU 13 controls the operation of PCU 11 so that the sum of the charged amounts of each assembled battery 12A, 12B, 12C becomes a predetermined amount Qs.

The higher-level controllers 20 include a processor and a memory (neither of which is shown), and send commands to the respective ECU 13. The higher-level controllers 20 are communicatively connected to servers (not shown) via a networked NW.

In the power storage system 1, each battery unit 10 is charged by the external system 900 at least during the midnight time period, and is discharged to the external system 900 at least during the daytime time period. Specifically, each battery unit 10 discharges each of the three assembled batteries 12 from the external system 900 at least during the midnight time period and to the external system 900 at least during the daytime time period.

### B. Configuration of Assembled Batteries

FIG. 2 is a diagram for explaining a part of the circuit configuration of the assembled battery 12. As shown in FIG. 2, the assembled battery 12 includes a plurality of units 120. Each unit 120 includes a cell 121, a voltage detection circuit 122, an ammeter 123, and a charging and discharging circuit 124. The charging and discharging circuit 124 includes a switch 1241.

The ammeter 123 and the switch 1241 are connected in series to the cell 121. The voltage detection circuit 122 is connected in parallel to the cell 121.

The voltage detection circuit 122 detects the voltage of the cell 121. Specifically, the voltage detection circuit 122 includes two connection terminals 1221 and 1222 for connecting to the positive electrode and the negative electrode of the cell 121, and a voltmeter 1223 provided between the connection terminal 1221 and the connection terminal 1222. The voltage detection circuit 122 detects the voltage between the two connection terminals 1221 and 1222 (that is, the voltage between the positive electrode and the negative electrode of the cell 121) by the voltmeter 1223.

The ammeter 123 measures the current value of the current flowing out of the cell 121 when the current is discharged from the cell 121 and the current value of the current flowing into the cell 121 when the cell 121 is charged. That is, the ammeter 123 measures the current value of the current flowing through the charging and discharging circuit 124 when the cell 121 is charged or discharged. In addition, the ammeter 123 also measures the amount of self-discharge of the cell 121.

Turning on the switch 1241 allows the cell 121 to be charged and discharged. The on/off operation of the switch 1241 is controlled by ECU 13.

The measured value (voltage value) by the voltmeter 1223 and the measured value (current value) by the ammeter 123 are sent to ECU 13. ECU 13 includes a processor 131 and memories 132.

### C. Outline of Process

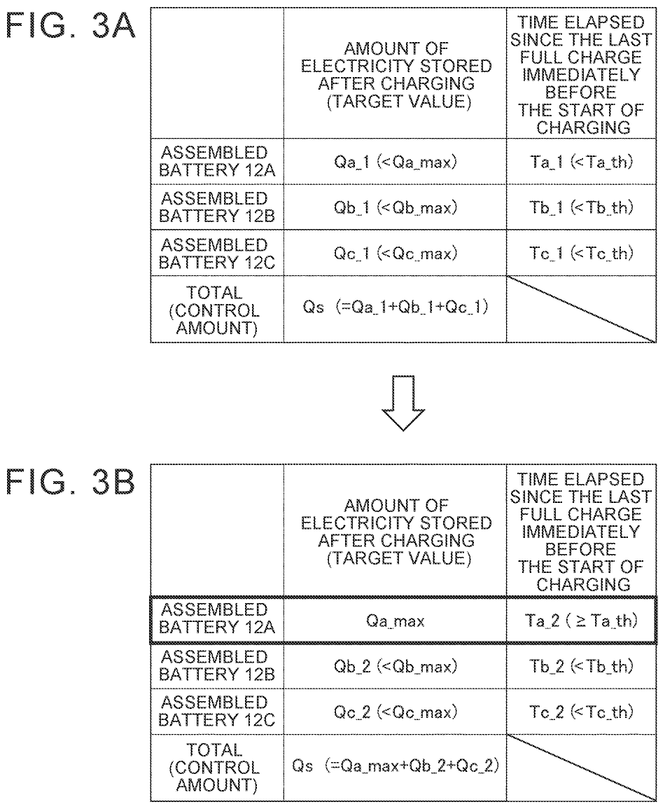

FIGS. 3A and 3B are diagrams for explaining an outline of a process in the power storage system 1. FIG. 3A is a diagram for explaining a state immediately before starting the Nth charge. FIG. 3B is a diagram for explaining a state immediately before starting the N+first charge. Here, N is a natural number.

### (1) Nth Charge

In the present embodiment, it is assumed that the elapsed time Ta_1 from when the assembled battery 12A of the battery unit 10 is fully charged last time immediately before starting the Nth charging is less than the threshold Ta_th for the assembled battery 12A. Similarly, it is assumed that the elapsed time Tb_1 since the assembled battery 12B was fully charged last time is less than the threshold Tb_th for the assembled battery 12B. Further, it is assumed that the elapsed time Tc_1 after the assembled battery 12C is fully charged last time is less than the threshold Tc_th for the assembled battery 12C. The respective thresholds Ta_th, Tb_th, Tc_th are stored in advance in ECU 13.

As described above, when each assembled battery 12A, 12B, 12C in the battery unit 10 is charged, ECU 13 controls the operation of PCU 11 so that the sum of the charged amounts of each assembled battery 12A, 12B, 12C becomes a predetermined amount Qs.

ECU 13 allocates an electric storage amount (target value) after charge for each assembled battery 12A, 12B, 12C. In the present embodiment, ECU 13 controls the operation of PCU 11 so that the amount of stored electricity after the assembled battery 12A is charged becomes Qa_1. Similarly, ECU 13 controls the operation of PCU 11 so that the amount of stored electricity after the assembled battery 12B is charged becomes Qb_1. ECU 13 controls the operation of PCU 11 so that the charge-up charge of the assembled battery 12C becomes Qc_1.

Qa_1 is less than the full charge capacity of the assembled battery 12A. Qb_1 is less than the full charge capacity of the assembled battery 12B. Qc_1 is less than the full charge capacity of the assembled battery 12C. The sum of Qa_1, Qb_1, and Qc_1 is Qs.

For example, ECU 13 may control Qa_1, Qb_1, and Qc_1 to be the same. Further, Ta_th, Tb_th, and Tc_th may be set to the same value.

(2) N+1st charge

Next, after completion of the N-th charging, as shown in FIG. 3B, it is assumed that, immediately before starting the N+1st charging, the elapsed time Ta_2 from the time when the assembled battery 12A is fully charged last time becomes equal to or more than the threshold Ta_th for the assembled battery 12A. It is assumed that the elapsed time Tb_2 after the assembled battery 12B is fully charged last time is less than the threshold value Tb_th, and the elapsed time Tc_2 after the assembled battery 12C is fully charged last time is less than the threshold value Tc_th.

ECU 13 performs the following control. ECU 13 controls the operation of PCU 11 so that the charge-up charge of the assembled battery 12A becomes Qa_max. That is, ECU 13 fully charges the assembled battery 12A.

Further, ECU 13 controls the operation of PCU 11 so that the amount of stored electricity after the assembled battery 12B is charged becomes Qb_2. ECU 13 controls the operation of PCU 11 so that the amount of stored electricity after the assembled battery 12C is charged becomes Qc_2. Qb_2 is less than the full charge capacity of the assembled battery 12B. Qc_2 is less than the full charge capacity of the assembled battery 12C.

Specifically, ECU 13 determines the values of Qb_2 and Qc_2 such that the value obtained by adding Qb_2 and Qc_2 to Qa_max (that is, the sum of the capacitances of the three assembled batteries 12A, 12B, 12C) is Qs. For example, ECU 13 sets the values (Qd/2) obtained by dividing the difference value (Qd=Qs−Qa_max) obtained by subtracting Qa_max from Qs by 2 to Qb_2 and Qc_2. However, such allocation is an example, and the present disclosure is not limited thereto.

By controlling such an ECU 13, the assembled battery 12A in which the elapsed time since the last full charge is equal to or longer than the threshold value Ta_th can be fully charged.

### D. Control Structure

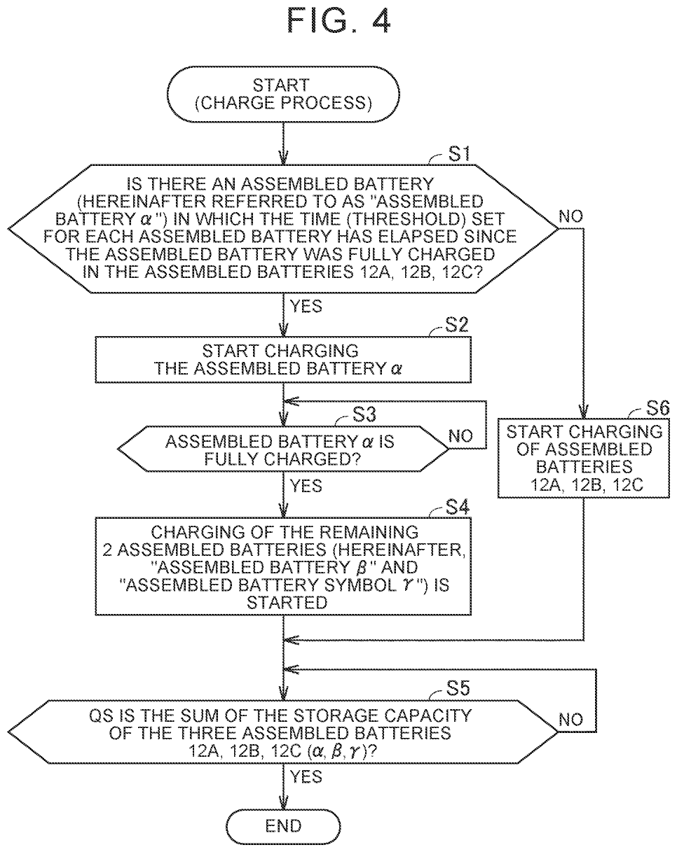

FIG. 4 is a flowchart for explaining a flow of a process for charging three assembled battery 12A, 12B, 12C. That is, the process when the assembled battery 12A, 12B, 12C is charged will be described below.

As shown in FIG. 4, in S1, ECU 13 determines whether or not there is a assembled battery 12 (hereinafter, also referred to as “assembled battery α” for convenience of explanation) in which the time (specifically, the above-described threshold Ta_th, Tb_th, Tc_th) set for each assembled battery has elapsed since the assembled battery 12A, 12B, 12C was fully charged last time.

If it is determined that the assembled battery α is not present (NO in S1), ECU 13 starts to charge the assembled battery 12A, 12B, 12C in S6. Specifically, as shown in FIG. 3A, ECU 13 controls the operation of PCU 11 so that the amount of stored electricity after the charge of each of the assembled battery 12A, 12B, 12C becomes Qa_1, Qb_1, Qc_1. Thereafter, ECU 13 advances the process to S5. In S6, ECU 13 may charge the three assembled batteries 12A, 12B, 12C at the same time or may charge them one by one.

If it is determined that the assembled battery α is present (YES in S1), in S2, ECU 13 starts to charge the assembled battery α. In S3, ECU 13 determines whether or not the assembled battery α is fully charged. ECU 13 typically determines whether or not the assembled battery 12a is fully charged (State Of Charge (SOC)=100%) based on the voltage of the assembled battery 12a.

When it is determined that the assembled battery α is fully charged (YES in S3), ECU 13 starts charging the remaining two assembled batteries (also referred to as “assembled battery β” and “assembled battery γ”) excluding the assembled battery α among the three assembled battery 12A, 12B, 12C. When it is determined that the assembled battery α is not fully charged (NO in S3), ECU 13 continues to charge the assembled battery α until the assembled battery α is fully charged.

In S5, ECU 13 determines whether the sum of the storage amounts of the three assembled battery 12A, 12B, 12C (i.e., assembled battery α, β, γ) is Qs. If it is determined that the sum of the charge amounts of the three assembled battery 12A, 12B, 12C is not Qs (NO in S5), ECU 13 continues charging in S4 or charging in S5. When it is determined that the sum of the storage amounts of the three assembled battery 12A, 12B, 12C is Qs (YES in S5), ECU 13 ends the series of charge processes.

In the above description, the configuration has been described as an example in which charging of the assembled battery β and the assembled battery γ is started after the assembled battery α is in a fully charged state, but the present disclosure is not limited thereto. ECU 13 may simultaneously initiate the charging of the three assembled batteries α, β, γ. Alternatively, ECU 13 may initiate charging of the assembled batteries β and γ from the middle of charging of the assembled battery α.

### E. Interim Conclusions

As described above, the power storage system 1 performs charging and discharging with respect to the external system 900. The power storage system 1 includes a PCU 11 connected to the external system 900, a plurality of assembled batteries 12 (12A to 12C) for discharging and discharging, which are connected in parallel to each other in PCU 11, and an ECU 13 for controlling the operation of PCU 11. When each assembled battery 12 is charged, ECU 13 controls the operation of PCU 11 so that the sum of the charged amounts of each assembled battery 12 becomes a predetermined amount Qs.

ECU 13, when each of the assembled battery 12 is charged, when the assembled battery α in which a predetermined time has elapsed since the previous full charge in a plurality of assembled batteries 12 is present, to charge the assembled battery α until a full charge. In addition, when there is a assembled battery α in which a predetermined time has elapsed since the previous full charge has occurred among the plurality of assembled battery 12 when each assembled battery 12 is charged, ECU 13 adjusts the storage amounts of the assembled battery β and γ other than the assembled battery α among the plurality of assembled battery 12 so that the sum of the storage amounts after the charge of each assembled battery 12 becomes a predetermined amount Qs.

According to such a configuration, the assembled battery α of the three assembled batteries 12 can be fully charged by using the three assembled batteries 12 that perform charging and discharging with the external system 900. Therefore, it is possible to fully charge the assembled battery α without using an adjustment battery different from the three assembled batteries 12 that perform charging and discharging with the external system 900.

When there is a plurality of assembled batteries in which a predetermined time has elapsed since the previous full charge of the plurality of assembled batteries 12, ECU 13 may preferentially fully charge the battery having the long elapsed time. Alternatively, ECU 13 may fully charge the plurality of assembled batteries 12 together.

### F. How to Set Thresholds

In the following, methods of setting the thresholds Ta_th, Tb_th, Tc_th will be described with reference to a plurality of exemplary embodiments. In the following description, when the threshold Ta_th, Tb_th, Tc_th is not distinguished, it is referred to as “threshold T_th”. The threshold T_th is set before the actual operation of the power storage system 1.

### (1) First Method

An ECU 13 or other device (not shown) is used to calculate, for each assembled battery 12, an error between an integrated value of a current when the assembled battery 12 is charged or discharged for a predetermined time and a theoretical value of a current flowing in the predetermined time, prior to the actual operation of the power storage system 1.

The threshold T_th (a predetermined time length) is set for each assembled battery 12 before the actual operation based on the error. For example, the threshold value Ta_th is set prior to the actual operation based on an error between the integrated value of the current when the assembled battery 12A is charged or discharged for a predetermined time and the theoretical value of the current flowing in the predetermined time. Specifically, the larger the error is, the shorter the threshold T_th is set. The determination of the thresholds T_th may be performed by another device or by an ECU 13. The determined thresholds T_th may be finally stored in ECU 13.

When the above error is large, the estimation accuracy of SOC is low. By fully charging the assembled battery 12 (assembled battery α) at an early stage, it is possible to improve the estimation accuracy of SOC. Therefore, as described above, the larger the error is, the shorter the threshold T_th, which is a reference period for determining whether or not full charge is required, is set, so that the estimation accuracy of SOC can be quickly increased.

### (2) Second Method

An ECU 13 or other device (not shown) is used to calculate variations in self-discharge amounts of the cells 121 (see FIG. 2) for each assembled battery 12 prior to actual operation of the power storage system 1. The threshold T_th (the length of the predetermined time) is set for each assembled battery 12 before the actual operation based on the magnitude of the variation in the self-discharge amount. Specifically, the threshold T_th is set to be shorter as the variation in the self-discharge amount is larger. The determination of the thresholds T_th may be performed by another device or by an ECU 13. The determined thresholds T_th may be finally stored in ECU 13.

In some embodiments, as the variation in the self-discharge amount increases, the equalization control of each cell 121 in the plurality of cells 121 in the assembled battery 12 may be performed at an early stage. When the assembled battery 12 is fully charged, each cell 121 in the assembled battery 12 is also fully charged, so that the cells 121 can be equalized in the assembled battery 12. Therefore, as described above, by setting the threshold T_th, which is a reference time for determining whether or not full charging is necessary, to be shorter as the variation in the self-discharge amount increases, the cell 121 can be equalized as quickly as the assembled battery 12 requiring equalization of the cell 121 can be.

### (3) Third Method

As illustrated in FIG. 2, the power storage system 1 (specifically, the battery unit 10) is provided in association with each of the plurality of cells 121, and includes a plurality of voltage detection circuits 122 each of which detects a voltage of the cell 121.

A device (not shown) is used to calculate the variation in impedance of each voltage detection circuit 122 for each assembled battery 12 before the actual operation of the power storage system. The threshold T_th (the length of the predetermined time) is set for each assembled battery 12 before the actual operation, based on the magnitude of the variation. More specifically, the threshold T_th is set to be shorter as the impedance variation is larger. The determination of the thresholds T_th may be performed by another device or by an ECU 13. The determined thresholds T_th may be finally stored in ECU 13.

The larger the variation of the impedance, the larger the variation of the self-discharge amount. In some embodiments, as the variation in the self-discharge amount increases, the equalization control of each cell 121 in the plurality of cells 121 in the assembled battery 12 may be performed as soon as possible, as described above. When the assembled battery 12 is fully charged, each cell 121 in the assembled battery 12 is also fully charged, so that the cells 121 can be equalized in the assembled battery 12. Therefore, as described above, the threshold T_th, which is a reference time for determining whether or not full charging is necessary, is set to be shorter as the variation in impedance is larger, so that the cell 121 can be equalized as quickly as the assembled battery 12 requiring equalization of the cell 121.

### G. Modified Example

(1) When the storage amounts of the plurality of assembled batteries β and γ are adjusted, and the assembled battery β is a ternary battery and the assembled battery γ is a LPF battery, ECU 13 may be configured to control PCU 11 so that the storage amount of the ternary battery (assembled battery β) is larger than the storage amount of LPF battery (assembled battery γ).

The internal resistance of LPF cell is higher than the internal resistance of the ternary cell. Therefore, by increasing the amount of electricity stored in the lower-resistance ternary battery to more than the amount of electricity stored in LPF battery (by preferentially charging the ternary battery) at the time of adjusting, the amount of electricity stored in LPF battery can be reduced as compared with the case where the amount of electricity stored in the ternary battery is larger than the amount of electricity stored in the ternary battery.

(2) In the above description, the configuration in which the three assembled batteries 12 can be connected to PCU 11 has been exemplified, but the present disclosure is not limited thereto. PCU and the power storage system 1 may be configured such that two or four or more assembled batteries are connected to PCU.

### H. Addendum

(1) A control method of a control device included in a power storage system that performs charging and discharging with an external system, the control method comprising: a step of controlling, by the control device, when charging a plurality of assembled batteries connected in parallel with each other to the power converter that is connected to the external system, an operation of the power converter such that a sum of a power storage amount after charging of each of the assembled batteries becomes a predetermined amount; a step of determining, by the control device, when charging each of the assembled batteries, whether there is a first assembled battery in which a predetermined time has elapsed since a previous full charging among the plurality of the assembled batteries; and a step of adjusting, in the step of controlling the operation of the power converter, when there is the first assembled battery, a power storage amount of a second assembled battery other than the first assembled battery among the plurality of the assembled batteries such that the first assembled battery is fully charged and the sum of the power storage amount after charging of each of the assembled batteries becomes the predetermined amount.

(2) A program that causes one or more processors (e.g., the processor 131 of the ECU 13) to execute the steps of the control method.

(3) A non-transitory computer-readable storage medium storing the program. It should be considered that the embodiments disclosed above are for illustrative purposes only and are not limitative of the disclosure in any aspect. The scope of the present disclosure is defined by the terms of the claims, and is intended to include any modifications within the scope and meaning equivalent to the terms of the claims.

What is claimed is:

1. A power storage system that performs charging and discharging with an external system, the power storage system comprising:
a power converter connected to the external system;
a plurality of assembled batteries used for the charging and discharging and connected in parallel with each other to the power converter; and
a control device that controls an operation of the power converter such that a sum of a power storage amount after charging of each of the assembled batteries becomes a predetermined amount when each of the assembled batteries is charged, wherein:
when each of the assembled batteries is charged and there is a first assembled battery in which a predetermined time has elapsed since a previous full charging among the plurality of the assembled batteries, the control device charges the first assembled battery until the first assembled battery is fully charged; and
when each of the assembled batteries is charged and there is the first assembled battery in which the predetermined time has elapsed since the previous full charging among the plurality of the assembled batteries, the control device adjusts a power storage amount of a second assembled battery other than the first assembled battery among the plurality of the assembled batteries such that the sum of the power storage amount after charging of each of the assembled batteries becomes the predetermined amount.

2. The power storage system according to claim 1, wherein:
an error between an integrated value of a current when the assembled battery is charged or discharged for a prescribed time and a theoretical value of a current flowing in the prescribed time is calculated for each of the assembled batteries prior to an actual operation of the power storage system;
a length of the predetermined time is set for each of the assembled batteries prior to the actual operation based on the error; and
the length of the predetermined time is set shorter as the error becomes larger.

3. The power storage system according to claim 1, wherein:
each of the assembled batteries includes a plurality of cells;
a variation in a self-discharge amount of each of the cells is calculated for each of the assembled batteries prior to an actual operation of the power storage system;
a length of the predetermined time is set for each of the assembled batteries prior to the actual operation based on a magnitude of the variation; and
the length of the predetermined time is set shorter as the variation becomes larger.

4. The power storage system according to claim 1, wherein:
each of the assembled batteries includes a plurality of cells;
the power storage system further includes a plurality of voltage detection circuits provided in association with each of the plurality of the cells and each detecting a voltage of the cell;
a variation in impedance of each of the voltage detection circuits is calculated for each of the assembled batteries prior to an actual operation of the power storage system;
a length of the predetermined time is set for each of the assembled batteries prior to the actual operation based on a magnitude of the variation; and
the length of the predetermined time is set shorter as the variation becomes larger.

5. The power storage system according to claim 1, wherein when power storage amounts of the plurality of the second assembled batteries are adjusted and when the plurality of the second assembled batteries includes a three-way lithium ion battery and an iron phosphate lithium ion battery, the control device controls an operation of the power converter such that a power storage amount of the three-way lithium ion battery is larger than a power storage amount of the iron phosphate lithium ion battery.
